(19) United States
(12) Patent Application Publication
(10) Pub. No.: US 2007/0164211 A1
(43) Pub. Date: Jul. 19, 2007

(54) Analysis arrray comprising heatable electrodes, and methods for chemical and biochemical analysis

(76) Inventors: Gred Uwe Flechsig, Teterow (DE); Peter Grundler, Rostock (DE); Joseph Wang, Tempe, AZ (US)

Correspondence Address: JORDAN AND HAMBURG LLP, 122 EAST 42ND STREET, SUITE 4000, NEW YORK, NY, 10168, US

(21) Appl. No.: 11/547,844

(22) PCT Filed: Apr. 5, 2005
(86) PCT No.: PCT/DE05/00643

§ 371 Date: Oct. 5, 2006

(30) Foreign Application Priority Data
Apr. 6, 2004 (DE) 10 2004 017 750.3

(51) Int. Cl. H01J 49/00

(52) U.S. Cl. 250/288

(57) ABSTRACT

The invention relates to an analysis array comprising heatable electrodes and methods for chemical and biochemical analysis. According to the invention, the surface (1) of at least one heatable electrode (13) is brought to a specific homogeneous temperature for chemical and biochemical analysis. The cross-sectional area of the electrode (1) varies along the longitudinal axis (8), and/or at least the heating current contacts (5, 5′) are insulated by means of a coating (4, 4′). According to the methods for simultaneously determining at least one chemical and/or biochemical substance, the individual electrodes are brought to a specific homogeneous temperature, respectively, the temperature being regulated by measuring the resistance and adjusting the heating current.

### BACKGROUND OF THE INVENTION

The invention relates to analysing arrays and methods for the use thereof.

It is known that in the chemical and biochemical analysis often several species (target molecules, analyte molecules) in one sample have to be analysed. So for example can be realised pH-measurements and the analysis of different ions with the help of arrays having different ion sensitive electrodes.

In genetics for example exists the problem to analyse a long nucleic acid sequence or to retrieve several different nucleic acid sequences in one sample. This can be carried out with the help of so called DNA-chips, wherein different nucleic acid molecules are immobilised as sonde molecules on respective own array elements and are used for the molecular detection of the target molecules. Thus it is possible to simultaneously analyse a lot of different fractional sequences of a natural nucleic acid.

Thereby are followed different ways for detecting the molecular detection event. In majority are used fluorimetric methods but sporadically also electromechanic methods.

From DE-OS 199 40 647 A1 is known that by applying an alternating voltage between working and reference or counter electrode it is reached that non-complementary sequences are repelling from the sonde oligos.

The electrical conductivity of integrated DNA double strands on the contrary is used according to DE-OS 199 21 490 A1 because in case of the existence of mismatching base pairs the conductivity decreases.

The state of affairs also implies the use of heatable electrodes which are modified with nucleic acid molecules. With this it is possible to carry out or measure all steps of hybridisation and detection at the respective own temperature, as described in DE-OS 199 60 398 A1.

From U.S. Pat. No. 6,255,677 B1 is known an analysing chip for analysing chemical and biological products on which are placed individually heatable electrodes that can be locally heated. The electrodes with their reaction surfaces have the shape of square spirals and can be directly heated. The cross-section of the spiral is constant over the whole length. In the majority of cases the heating of the electrodes is carried out indirectly by a laser source with especially arranged lens systems or by resistance wires additionally placed near the electrodes.

The disadvantage of the known heatable electrodes and arrays or analysing chips consisting of individually heatable electrodes is that the temperature of the electrode surface or the temperature of the reaction surfaces of the electrodes on the array is not uniform on the whole electrode surface. Undesired temperature gradients develop on the electrode surface. The cause for this lies in the heat dissipation by the heating current supply leads with big cross-sectional area. These big cross-sectional areas are necessary because otherwise not the electrode to be heated but the current supply leads would heat up. The consequence is a decrease of temperature at the electrodes in the direction of both heating current pads. Due to this frequently occur unintended positive detection results during hybridisation of nucleic acids though target and sonde strands are not hundred percent complementary to each other. One cause is that mismatching double strands still have a certain stability. The “melting temperature” Tₘ, i.e. the temperature at which the two strands of a double strand nucleic acid are separating from each other, however is lower by about 5 K per mismatching base pair in comparison to a double strand nucleic acid without mismatches. This can be used to detect mismatching base pairs, but presupposes a precise adjustment of the temperature on the whole electrode surface. The longer a double strand, the higher its melting temperature. If the sonde is short enough then Tₘ lies only few degrees over room temperature. If thereby occurs a mismatching pair the respective mismatching double strand consequently is unstable already at room temperature.

The described in DE-OS 199 40 647 A1 determination method of applying a voltage/electrical current to the working electrode has the disadvantage that undesired redox side reactions with components of the sample matrix or even the analyte itself may occur. Dependant on length and guanidine/cytosine-content of the sonde frequency highly different currents are necessary for discriminating mismatching base pairs.

The utilisation of the conductivity of double strand DNA as described in DE-OS 199 21 940 A1 also shows disadvantages. So the discriminating effect between fully complementary strand (target) and mismatching strand with regard to certain base pairs is heavily decreased or barely existing (thymine-thymine, thymine-cytosine).

By using arrays with heatable working electrodes, e.g. nucleic acid modified electrodes, as described in DE-OS 199 60 398 A1 or U.S. Pat. No. 6,255,677 B1, with temperature indeed is introduced another variable parameter which shall optimise and accelerate the steps of hybridisation as well as enable a regeneration of the sonde molecules. But of disadvantage is, that at one electrode only one analytic species can be determined at one time or the temperature is not uniform over the whole reaction surface of the single electrode.

Also problematic are disturbing factors which influence the preset electrode temperature. So for example has to be equalised a fluctuation of the ambient temperature or a changing temperature of the supplied sample solution. If these disturbing factors are not compensated, no exact calibration of the necessary electrode temperature is possible.

Another disadvantage is that measuring and electrical heating at the same time requires the conductive separation of the single electrodes of the array because otherwise no individual electrochemical measurements are possible.

A further disadvantage of working with heated electrodes often is the relevant heating of the sample solution. Especially in case of very small sample volumes, as typically occur in biochemical analyses, already a short-time use of heated electrodes can lead to a warm up of the sample solution by several kelvin. This aggravates the calibration of the desired electrode temperature, decreases the useful micro stirring effect and consequently leads to an undesired thermal stress of the whole sample solution.

### SUMMARY OF THE INVENTION

According to the invention there is provided an analysing array with selectively heatable electrodes for the chemical and biochemical analysis,
a) the single electrode surfaces of which can be brought to a respective own temperature that has the same value on the whole electrode surface, and
b) which enables simultaneous electrical heating and electrochemical measurements without the single electrodes disturbing each other and
c) which does not lead to an undesired warm up of the sample solution, and a respective method of chemical and biochemical analysis for simultaneous determination of one or several target molecules with respective own precisely adjustable as well as controllable regarding time and space electrode temperatures.

Therefore, according to this invention it is foreseen, that the electrodes of the array preferably consist of an arrangement of electrically conductive layer-structured elements of any thickness especially of carbon, platinum, palladium, gold, iridium, bismuth, cadmium, nickel, zinc, silver, copper, iron, lead, aluminium, manganese, mercury or their alloys, which are advantageously produced by sputtering or depositing on an electrically non-conductive substrate as for example glass, glass-like substances, ceramics, different kinds of polymers and so on as planar carriers.

Every single electrode on the carrier at each end has an electrical heating current contact for supplying current and can be electrically heated. A special advantage is that these heating current contacts with the current supply leads also are used for coupling electrochemical as well as electrical measuring instruments, e.g. potentiostats, galvanostats, ammeters or voltameters. The heating current contacts and the electrical current supply leads are potentially coated with appropriate material as glass, varnish or polymeric plastics for electrical insulation to avoid the contact with the electrolyte (sample solution) in this place.

According to this invention the arrangement of the layer-structured conductive elements is not limited to sputtering or depositing, but it has also shown that the electrodes on the carrier can be also produced by electroplating or respective arrangement of thin metallic wires, strips or similar. Heatable carbon electrodes especially can be realised in form of printed layers, as pastes of carbon powder or as glass carbon in form of layers and rods.

According to this invention the cross-section area of the single electrodes perpendicular to the longitudinal axis of the electrode over its length is variated in such a way that the cross-section of the electrode is smaller near the heating current contacts which cause a high loss of heat.

Due to the locally smaller cross-section near the heating current contacts this part of the electrode is heated more intense when applying the same heating current. But due to the higher thermal dissipation over the heating current contacts with the coupled electrical current supply leads this more intense warm up is just compensated.

According to this invention this makes it possible to reach the same temperature on the whole electrode surface.

It has shown that it is especially advantageous if the electrode surface as reaction surface of the electrode has a long stretched-out but approximately oval shape, wherein the heating current contacts with the coupled electrical current supply leads are arranged at the small ends of the electrodes. Also possible is a steady reduction of the cross-section area in the direction of the heating current contacts.

Thus it has shown that the ratio of the smallest cross-section area of the electrode at the heating current contacts to the biggest cross-section of the electrode can be from one to one up to one to three. As especially advantageous has turned out a ratio of one up to two.

But according to this invention the ratio is not limited to this because it always depends on different influencing factors. First on the extent of heat dissipation through the current supply lines at the heating current contacts, but also on how big the difference is between electrode temperature and ambient temperature. In accordance with the operating conditions the shape of the electrodes is optimally realised.

Due to the geometry of the electrode according to this invention it is possible to get an uniform temperature on the whole electrode surface of the single electrodes of the array. This uniform temperature for example is especially necessary for the exact sequence determination of nucleic acids which requires an exact temperature calibration of the electrode surface especially regarding relatively short nucleic acid chains. Only due to this the exact determination of the chemical or biochemical material, which is to be analysed, becomes possible. Mistakes in the determination e.g. nucleic acid sequences hence now can be excluded, whereas up to now already small inaccuracies in temperature calibrations or temperature gradients on the electrode surface especially in case of relatively short sequences often led to misdetections.

But according to this invention it is also possible to additionally cover the end section of the electrode surfaces at the heating current contacts with a thermal and electrical insulating layer to reduce the loss of heat near the heating current contacts, so that in axial direction occurs no or only a small loss of heat. This cover can be limited to the absolute surrounding of the heating current contact as well as to an extended section of the electrode surface. Also a combination of both is possible. In case of a partial covering of the electrode at the ends of the heating current contacts a smaller or even no change of the cross-section area alongside the electrode is required, but due to that the size of the reaction surface on the single electrode is slightly reduced.

But there is also the possibility to dimension the length of the electrode extremely generous so that the so called “cold” end sections near the pads amount to a very small fraction in relation to the whole electrode. In this extreme case the temperature deviation at the ends can be neglected.

According to this invention it is also possible to place a third contact at the electrode. This contact, the so called median (third) contact in case of symmetric contact arrangement for coupling an electrochemical measuring instrument always has to be designed that small that the loss of heat in this place possibly is negligible small. This is easily possible because electrochemical currents to be measured are smaller than the heating current by about 6 orders.

The current supply leads at the single electrodes can be carried out in different ways. In one embodiment the current supply leads are led through the carrier from beneath after the electrode. But there is also the possibility to lead the current supply leads to the edge of the array in the same plane as the electrode. Both modifications, also in the mixed form, are possible and shall not restrict the invention.

The voltage drop of the heating current over every single electrode with the electrode surface shape according to this invention is measured. Together with the value of the heating current flowing through this electrode the resistance is calculated according to the formula R=U/I. Over the relation R=R₀ (1+αT) (with the fiducial value of the resistance R₀ and the temperature coefficient α of the electrical resistance) the measured resistance is a scale for the electrode temperature.

The so determined resistance in place of the electrode temperature is individually adjusted for every electrode by adjusting the respective heating current (multi-channel-method). Thus disturbing thermal influences, which can also slightly different act on every electrode, are compensated. Preferably the measuring system to avoid interferences is coupled to the control system via an optocoupler.

The common current supply for example can be realised via a transformer. The current flow at the single electrodes is interrupted at the moment of the electrochemical measuring by upstream and downstream multiple double circuit breakers. The applied to the electrodes voltage and current intensity are separately measured at each electrode and the determined values are transmitted to the related controller. Every controller on its turn is coupled with the related actuator (e.g. an electronic resistor) which influences the current quantity that shall be applied to the electrode. Thus it is possible to exactly control the temperature of every single electrode.

But according to this invention it is also possible to globally control the temperature of the single electrodes by adjusting the current for the whole array by means of one actuator (e.g. an electronic resistor). This is less complicated because it is a single channel system. In this case individual fluctuations of temperature are not taken into account. The measuring signal herein is achieved by a central temperature sensor which is coupled to the control unit.

In this simple arrangement the setting of the individual temperatures of the single electrodes is realised by a trim pot placed before every single electrode in addition to the basic setting and controlling of the whole array through a central actuator.

In this case the array also is supplied with current via a transformer. The temperature is determined by at least one temperature sensor placed on the array between the electrodes and the temperature value is transmitted to the control unit which influences at least one actuator (e.g. an electronic resistor) for the whole heating system. Thus it is achieved that a certain current intensity, which is necessary for the heating of the electrodes, is centrally adjusted and controlled.

Via multiple double circuit breakers, in dependence on the position of the circuit breakers, the single electrodes are supplied with current or not supplied. Due to this it is possible to get different temperatures at the electrodes on the array, to globally control the set temperatures and separated with regard to time to carry out a multitude of electrochemical measurements without the single electrodes disturbing each other during the course of the latter.

In case electrical heating and electrochemical measuring are carried out one after the other it is possible, as described above, to electrically separate the electrode array from the heating system by means of multiple double circuit breakers. This proceeding is ruled out in case of simultaneous measuring and heating.

Instead, here has to be realised a conductive separation by separating each electrode from the heating system by an own transducer. This can be easily realised with the global temperature control. In case of the individual temperature control an additional conductive separation is also necessary in the control loops between the measuring instruments for the electrical resistance of the electrode and the respective actuator (e.g. electronic resistor) in the heating system. This for example can be realised with optocouplers.

A cooling element with a plane bottom surface preferably made of aluminium or copper is placed above the array so that the sample solution is enclosed in a thin layer between array and cooling element. The cooling element for example can be connected to a passive sufficiently dimensioned ribbed heat sink. In case of bigger quantities of heat or initial temperatures below the room temperature also a Peltier element can be coupled to the cooling element or be identical with it.

The plane surface of the cooling element which is in contact with the sample solution advantageously is coated with an inert gold or platinum layer. The cooling element because of its big surface advantageously also can be used as counter electrode.

Other advantages, details and elements characterising the invention exemplary follow from the following closer explanations at hand of the enclosed figures.

### BRIEF DESCRIPTION OF THE DRAWINGS

FIG. 1a Array with 16 electrodes, top view

FIG. 1b Array with electrodes, cross-section

FIG. 2 Array with electrodes, two-dimensional arrangement

FIG. 3 Array with U-shaped electrodes, wherein always two are connected to a symmetrical arrangement

FIG. 4 Array with 16 electrodes with temperature sensor, top view

FIG. 5 Basic block diagram of the individual temperature control

FIG. 6 Circuitry of the array for individual temperature control and coupling via multiple double circuit breakers

FIG. 7 Circuitry of the array for individual temperature control and coupling of the electrodes via respective own transducers

FIG. 8 Basic block diagram of the global temperature control

FIG. 9 Circuitry of the array with central temperature control and coupling via multiple double circuit breakers

FIG. 10 Circuitry of the array with central temperature control and coupling of the electrodes via respective own transducers

FIG. 11 Cooling of the sample solution on the array with a passive ribbed heat sink

FIG. 12 Active cooling of the sample solution on the array with a Peltier element and a ribbed heat sink

### DETAILED DESCRIPTION OF THE INVENTION

In the following the same parts are signed with the same reference indicators.

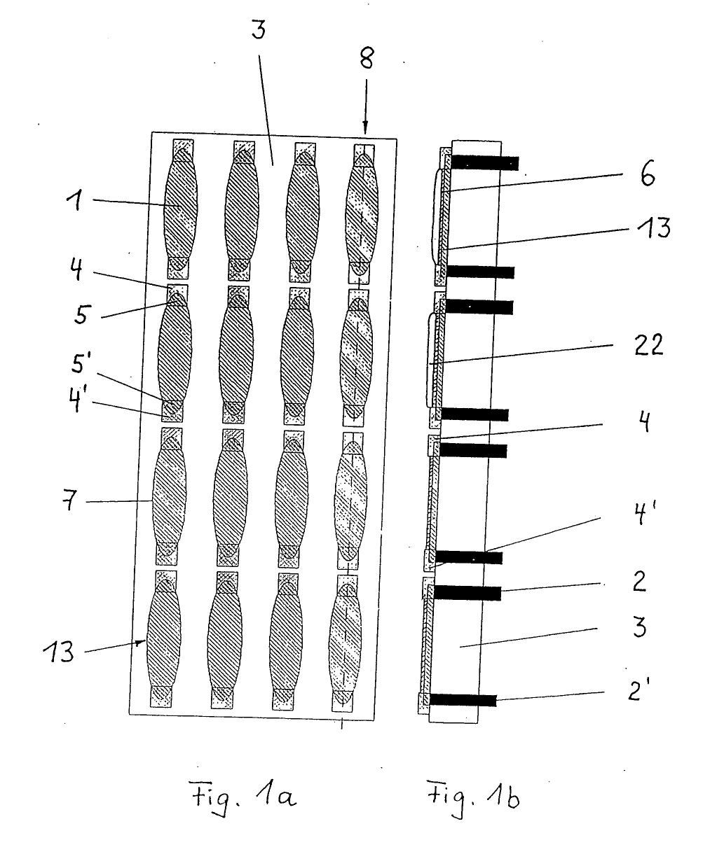

In FIG. 1a and 1b is shown an array with 16 electrodes 13 made of gold which by sputtering were deposited on a carrier 3 of glass. Each electrode is modified with an individual nucleic acid SAM consisting of HS-modified sonde strands, the reaction medium 6, which serves for detecting of a target strand in the sample solution 22. The edge 7 of the electrode therein is slightly arcuated so the shape of the electrode surface 1 has a long stretched-out oval geometry. The ratio between the biggest breadth of the electrode surface 1 and the smallest breadth immediately at the covering layer 4 of the heating current contacts 5 is 10:7. The heating current contacts 5, 5′ at the ends of electrode 13 are coupled with the current supply leads 2, 2′ for heating of the electrode 13, which, as is obvious from FIG. 1b, are led from beneath through carrier 3. The ends of electrode 13 by means of layer 4, 4′ made of plastics are additionally covered. Thus are given an electrical insulation with regard to the adjacent solution and if necessary in case of larger covering of the electrode surface 1 also a decrease in the loss of heat.

It is also obvious that the breadth of the electrode surface 1 is decreasing along the longitudinal axis 8 towards the heating current contacts 5, 5′, in this case with a ratio of 10:7.

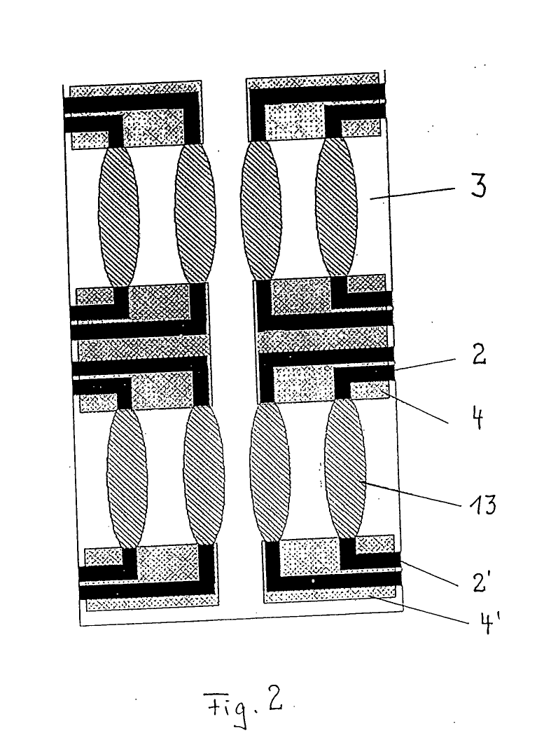

In FIG. 2 is shown an array arrangement in two-dimensional form. The electrode 13 at the ends is in contact with the current supply leads 2, 2′ which in this case are horizontally placed on the carrier 3 such as the electrode 13. The current supply leads 2, 2′ are covered with an insulation material made of plastics as covering layer 4,4′.

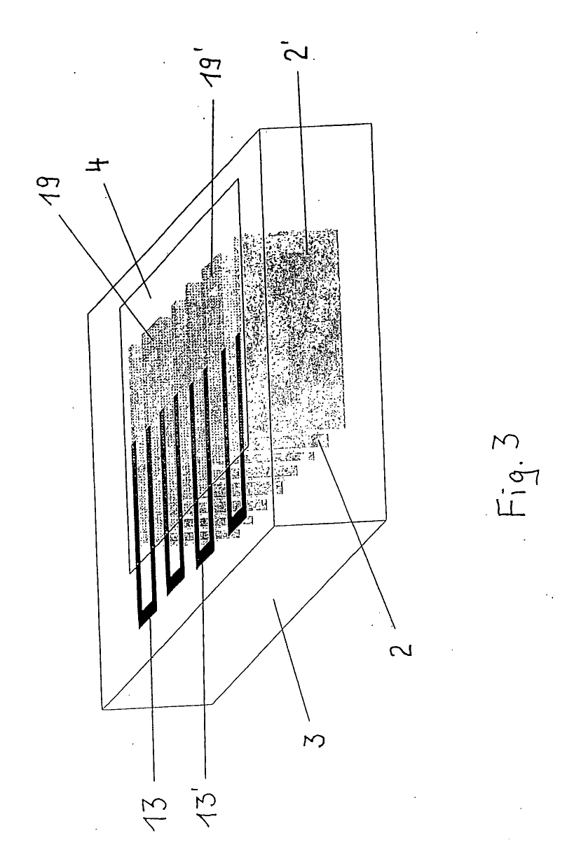

The array according to this invention alternately is shown as a packet like in FIG. 3. formed of vertical metal sheets as currents supply leads 2, 2′. The metal sheets are arranged parallel and separated by insulation layers. The upper bare parallel edges of the metal sheets (current supply leads 2, 2′) serve as heating current contacts 5, 5′ of the thin heatable electrodes 13, 13′.

This arrangement guarantees that despite of small dimensions the cross-section areas of the power supplies 2, 2′ are much bigger than the cross-section area of the heatable electrodes 13, 13′. The uniformity of the temperature distribution on the electrode surface 1 of the electrode 13 and inside the single electrode 13 is guaranteed because not a small part, which individually has to be determined empirically for the individual case, of the electrode surface 1 near the current supply 2 is covered by the electrically insulation covering layer 4. The heatable electrodes 13, 13′ consist of two U-shaped parts connected with each other and forming an symmetrical arrangement. At the junction the median contacts 19, 19′ are foreseen for coupling electrochemical instruments.

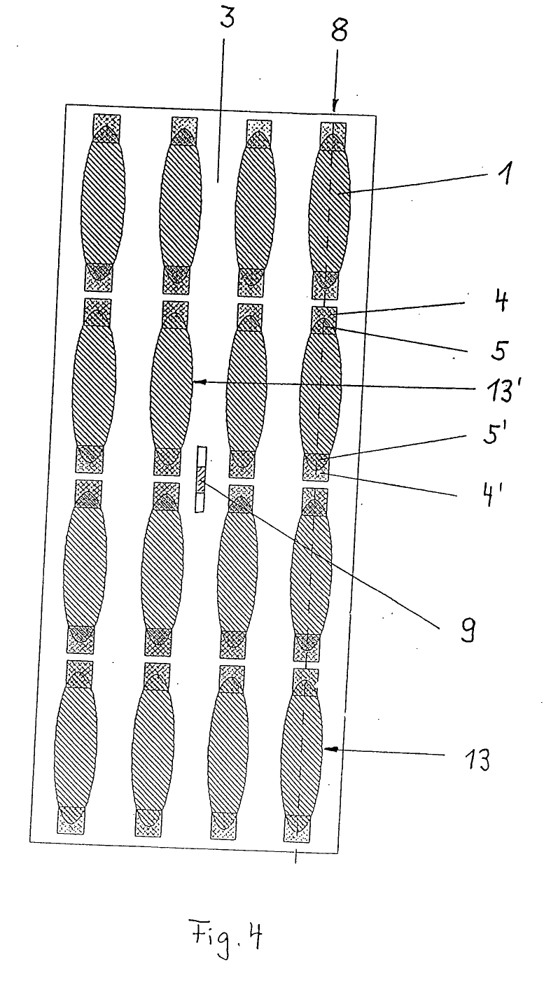

In FIG. 4 is shown an array similar that of FIG. 1. But in this arrangement the temperature is measured between the electrodes 13, 13′ by a temperature sensor 9 which influences a control unit not shown here.

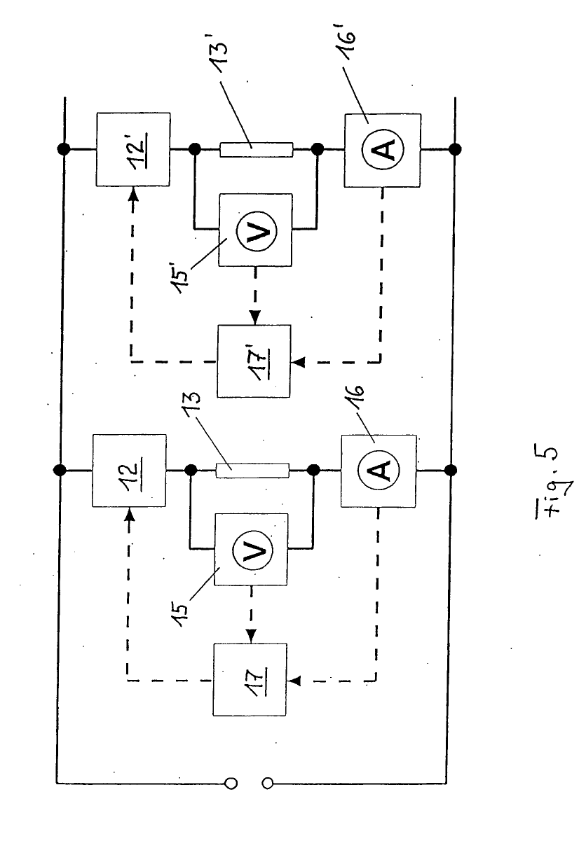

FIG. 5 shows the basic block diagram of an individual temperature control of the array electrodes, wherein two single control loops of the array are shown in detail. The heating current applied to the electrodes 13, 13′ is adjusted by actuators (e.g. electronic resistors 12, 12′). The control of the actuators is carried out via the controllers 17, 17′ which get the necessary measured data from the measuring elements for current (ammeter 16, 16′) and voltage (voltmeter 15, 15′).

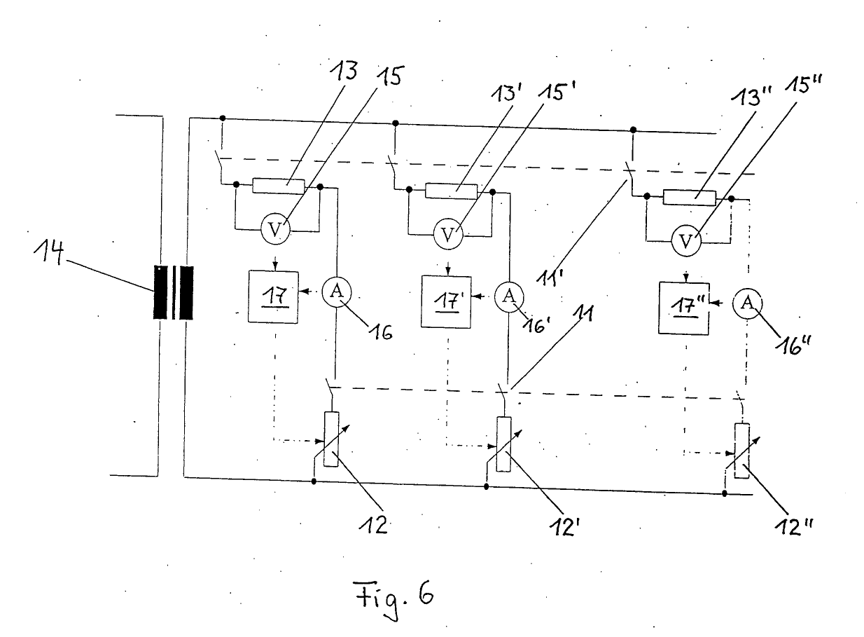

FIG. 6 shows the circuitry for the individual control of the current intensity of an array according to this invention, wherein heating and electrochemical measuring are carried out one after the other. The power supply is realised via the shown central transformer 14. Multiple double circuit breakers 11, 11′ before and after the electrodes 13, 13′, 13″ switch on or off the current flow through the electrodes 13, 13′, 13″ for heating them and allow for the conductive separation of the electrodes 13, 13′, 13″ from each other for the purpose of electrochemical measurements. At the same time via voltmeters 15, 15′, 15″ are measured the applied to the electrodes 13, 13′,13″ voltages and the applied current intensities by means of the ammeters 16, 16′, 16″. The determined data are transmitted to the controllers 17, 17′, 17″ allocated to the electrodes 13, 13′, 13″, which influence the electronic resistors 12, 12′, 12″ for the current flow.

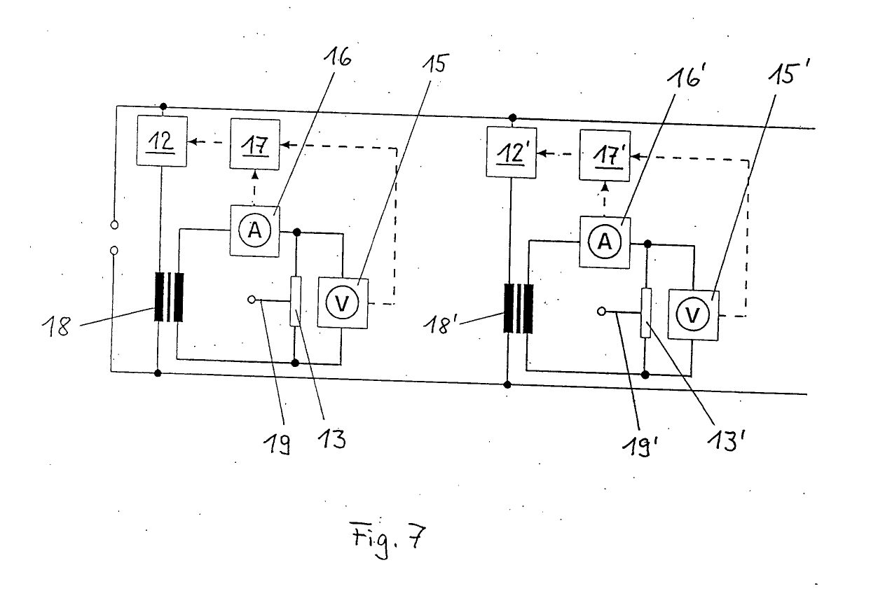

FIG. 7. shows the circuitry for an individual temperature control, wherein heating and electrochemical measuring are carried out simultaneously. In this case the heated electrodes 13, 13′ at every moment are electrically separated from each other. The coupling to the heating current supply is realised with the help of individual transducers 18, 18′.

For the symmetrical coupling of the electrochemical measuring instrument to the heated electrodes 13, 13′ serve the median contacts 19,19′.

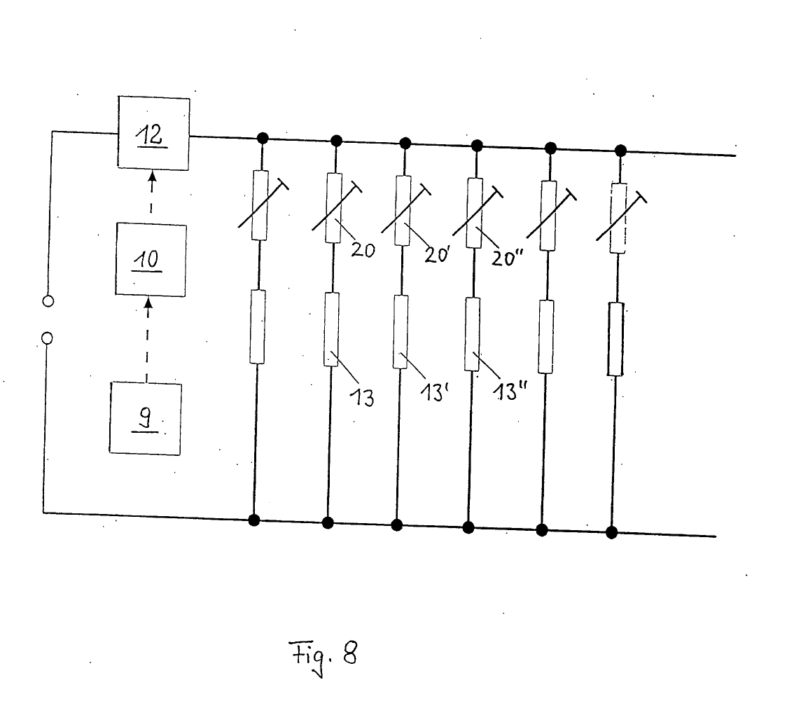

FIG. 8 shows the basic structure of a central temperature control of all electrodes with one central actuator (e.g. electronic resistor 12) which influences the heating current for all electrodes 13, 13′, 13″. It is triggered by the control unit 10 which gets its data from the measuring element (temperature sensor 9). A different heating up is reached by series trim pots 20, 20′, 20″.

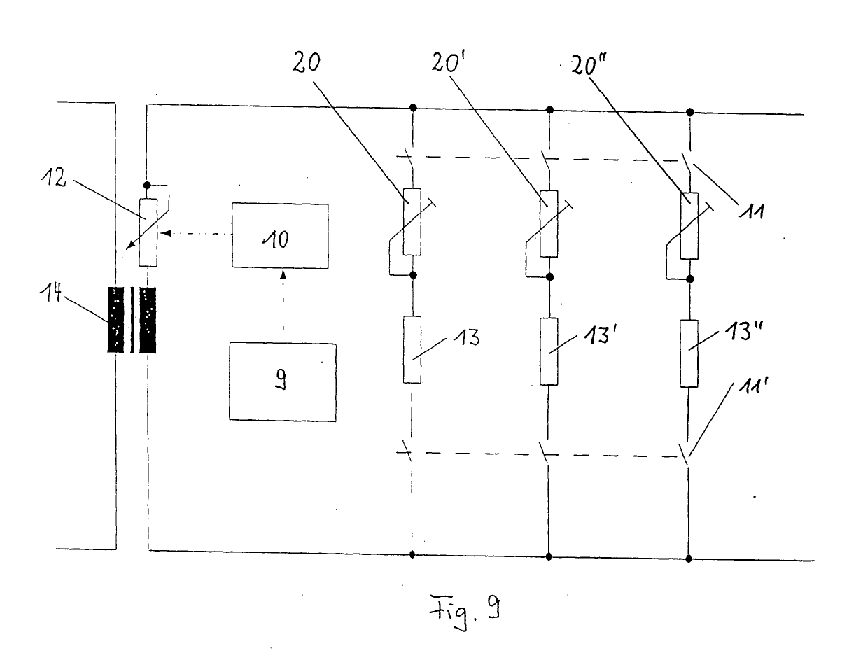

In FIG. 9 is shown a simple variation, wherein simultaneous heating and electrochemical measuring are not foreseen. Here the current supply is also realised via a central transformer 14, wherein the current which shall flow through the electrodes 13, 13′, 13″ is centrally controlled via the electronic resistor 12. This resistor 12 is controlled by the control unit 10 which is influenced by the temperature sensor 9 placed on the array, as is obvious from FIG. 4. Before and after the electrodes 13, 13′, 13″ again are placed multiple double circuit breakers which allow a conductive separation of the electrodes from each other for the purpose of electrochemical measurements. By trim pots 20, 20′, 20″ which are directly allocated to the electrodes 13, 13′, 13″ a difference of the current for heating up between the single electrodes 13, 13′, 13″ can be adjusted to realise a different heat up of the electrodes 13, 13′, 13″.

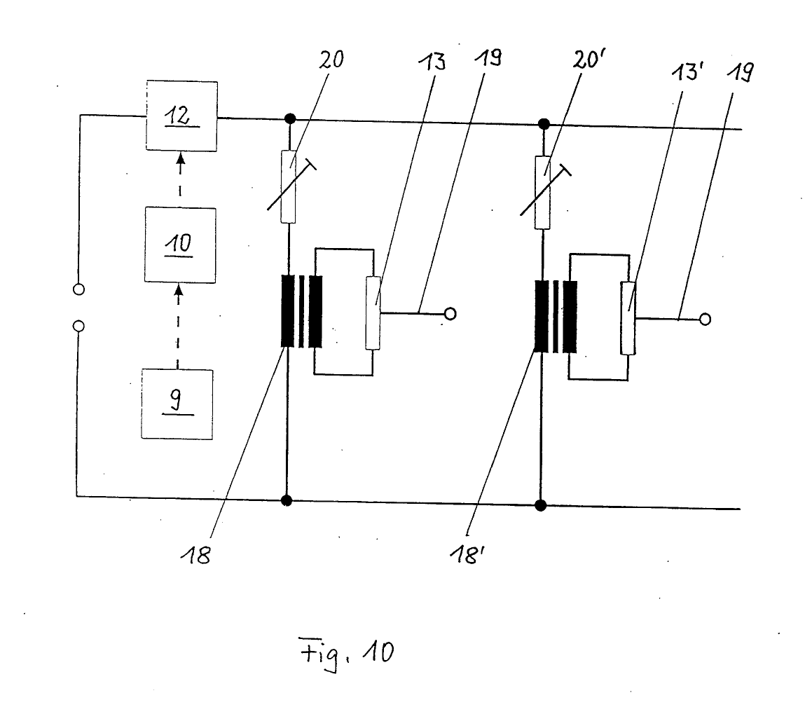

FIG. 10 illustrates a simple variation of how with the help of individual transducers 18, 18′, the electrodes 13, 13′, can be permanently separated electrically from each other, so that heating and electrochemical measurements are possible simultaneously. For symmetrical coupling of an electrochemical measuring instrument to the heated electrodes here also serve the median contacts 19, 19′.

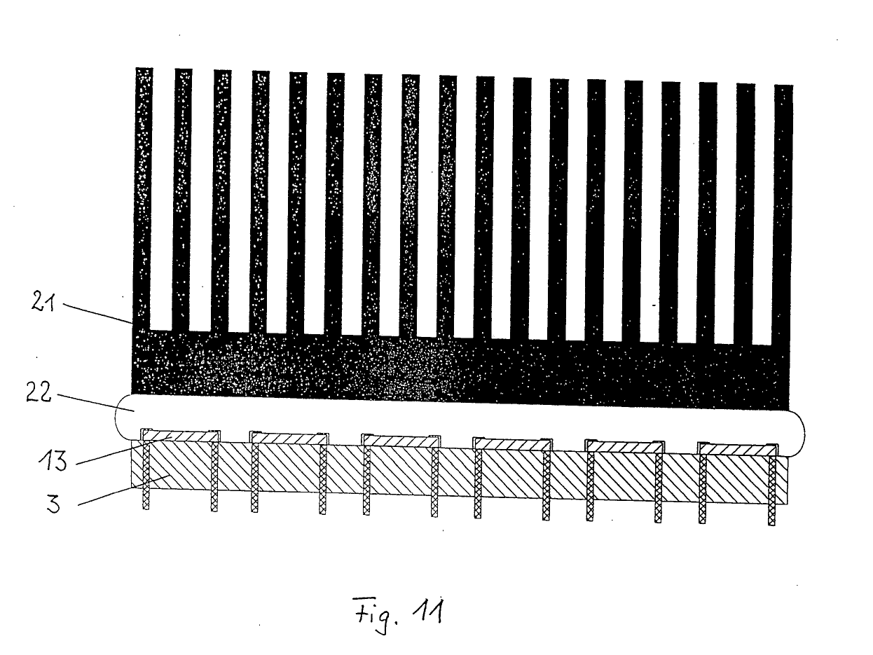

In FIG. 11 is shown how with the help of a passive heat sink 21 the temperature of the sample solution 22 is kept constant. The sample solution 22 in form of a thin layer is located between the electrode array (consisting of the electrodes 13 on the carrier 3) and the heat sink 21.

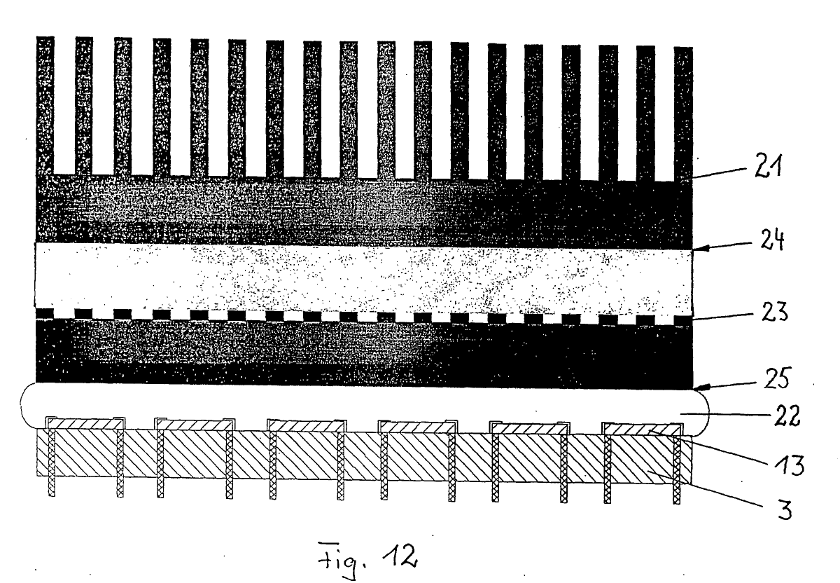

FIG. 12 shows a variation with active cooling of the sample solution 22. Between heat sink 21 and sample solution 22 located on electrode 13 an carrier 3 is placed a Peltier element 23. Adjacent to the hot surface 24 of the Peltier element 23 is a heat sink 21. Thus on the one hand the sample solution 22 at the cooled cold surface 25 of the Peltier element 23 can be cooled down to values beneath the ambient temperature and on the other hand the temperature of the sample solution 22 by adjusting the Peltier current can be adjusted to any value.

Advantageously the bottom surface of the heat sink 21 or the Peltier element 23 which is in contact with the sample solution 22 is covered with gold or platinum. This gold or platinum layer serves as common counter electrode of the working electrodes of the array for the purpose of electrochemical measurements.

### EMBODIMENT 1

The array consists of an arrangement of layer-structured precious metal elements, electrodes 13, which were produced by sputtering or depositing on carrier 3 made of glass.

The oval shape of the electrodes 13 according to this invention is shown in FIG. 1, 2 and 4. According to this invention due to this shape is reached a uniform heating up of the surface of the single electrodes 13 as soon as the heating current is switched on. Each electrode 13 has two electrical heating current contacts 5, 5′ to which are coupled current supply leads 2, 2′ made of copper with a big cross-section area and can be electrically heated. The current contacts 5, 5′ also serve for coupling electrochemical measuring instruments, for example potentiostats, galvanostats, voltmeters. In FIG. 1b are shown covering layers 4, 4′ electrically insulating the heating current contacts 5, 5′ and the electrical current supply leads 2, 2′.

### EMBODIMENT 2

The array according to this invention consists of an arrangement of thin gold wires with a diameter of 25 mm. Every piece of wire is a heatable element of the analysing array. It is modified on its surface with a self assembled monolayer of nucleic acid oligomers. All wire pieces can be triggered separately and thus can be passed by respective individually adjusted heating currents. The hybridisation and its detection run as given in embodiment 3. A uniform temperature along the wire is reached by a partly covering with insulating material in the area of the heating current contacts, the dimensions of which have to be empirically determined.

### EMBODIMENT 3

Oligonucleotides containing 45 bases and modified at one end with a HS- (CH)₆—group are located in form of a self assembled monolayer on a gold layer or a gold wire. These oligonucleotides serve as sonde molecules and should the occasion arise establish a connection with existing analyte or target molecules if their base sequences are sufficiently complementary to each other. Due to this the target molecule can be identified with a definite certainty. The gold layer with its property as ohmic resistor is part of a heating circuit. This gold layer also is connected to an electrochemical measuring circuit. According to this invention this gold layer together with layers of the same kind is located on a glass substrate, the carrier, and forms an electrode of a thermal analysing array. The array electrodes are produces by sputtering or depositing of gold on the glass substrate. In FIG. 1 is shown such an array consisting of 16 elements. The strength of the connection between sonde and target molecule inter alia depends on the length of the molecules, the content of guanine-cytosine base pairs as well as on the degree of matching between sonde and target sequences. At sufficiently high temperature the connection is separated. By selecting the correct temperature now can be discriminated between molecules with high and low matching. Because each array electrode is characterised by an own base sequence of the sonde molecules immobilised on it, it also has its own “correct” temperature for discriminating fully complementary and mismatched molecules. According to this invention herein the temperature for each array electrode is individually adjusted via the respective heating current and all electrodes together are centrally controlled via a temperature sensor. Thus can be compensated external thermal influences like variable ambient temperatures or different temperatures of sample solutions.

### EMBODIMENT 4

A big quantity of samples with regard to certain nucleic acid sequences are analysed by means of the hybridisation technique. The sequence on the one hand is very long or on the other hand the quantity of sequence sections is very large, so that the use of a DNA-array is necessary. The thermal analysing array equipped with appropriate sonde molecules herein can be used as detector in a flow apparatus. Every single sample is determined in a cycle consisting of hybridisation, electrochemical signal transduction and thermal regeneration. In the course of the regeneration the sonde molecules are thermally separated from the target molecules by heating over the melting temperature of the respective nucleic acid sequence. Afterwards the same array can be used for the next sample what facilitates a big sample throughput. The hybridisation occurs at a temperature which with high selectivity allows the formation of the hybrid complexes only in case of fully complementary target sequences.

### EMBODIMENT 5

A further embodiment is the analysis of proteins. In the proteome analysis occurs the problem to simultaneously characterise different protein species because a proteome is characterised by the respective condition of all existing proteins and permanently is tempolabile.

Proteins can be determined by immunoassays which are based on molecular detection (Lock-and-Key Principle). This can be carried out with the help of an analysing array according to this invention simultaneously at different adjusted to the respective species temperatures.

### EMBODIMENT 6

An aqueous sample shall be analysed with regard to pH-value, chloride, glucose and lead content. This can be carried out by means of the electrochemical methods potentiometric titration, amperometric titration and invers voltammetric titration. Here also is used a simple selectively heatable analysing array with four reaction surfaces (electrodes) which are all respectively modified: It consists of two ion sensitive electrodes for the potentiometric determination of pH-value or chloride content respectively at room temperature, an enzyme modified electrode for the amperometric glucose determination at 40° C. and a carbon layer electrode for the invers voltammetric lead determination with a step of enrichment at 80° C.

### EMBODIMENT 7

The activity of an enzyme shall be simultaneously determined at temperatures of 0, 10, 20, 30, 40, 50 and 60° C. For this is used an analysing array which is connected with a Peltier element for cooling. The reaction surfaces are modified with the respective enzyme and brought into an electrochemical cell. With the help of the Peltier element the initial temperature of the array is decreased to 0° C. By selective heating the single reaction surfaces are brought to the desired temperatures between 0 and 60° C. The activity of the enzyme after addition of the substrate can be amperometricly observed on the single array elements.

List of Used Indicators

1 electrode surface
2, 2′ current supply lead
3 carrier
4, 4′ covering layer
5, 5′ heating current contact
6 reaction medium
7 edge of reaction surface
8 longitudinal axis
9 temperature sensor
10 control unit
11, 11′ circuit breaker
12, 12′, 12″ resistor
13, 13′, 13″ electrode
14 transformer
15, 15′, 15″ voltmeter
16, 16′, 16″ ammeter
17, 17′, 17″ controller
18, 18′, 18″ transducer
19, 19′, 19″ median contact
20, 20′, 20″ trim pot
21 heat sink
22 sample solution
23 Peltier element
24 hot surface of the Peltier element
25 cold surface of the Peltier element

1-26. (canceled)

27. Analyzing apparatus for chemical or biochemical analysis, comprising at least one electrically conductive, heatable electrode having a surface which is to be heated by electrical current, the electrode being supported by a carrier, and electrical contacts at opposed ends of the electrode surface for supplying heating current to the electrode, and wherein
a) cross-section area of the electrode perpendicular to a longitudinal axis of the electrode is varied, and/or
b) the contacts and/or the ends of the electrode surface are provided with a thermally insulating coverings, or
c) ratio of length of the electrode cross-section area of the electrode perpendicular to the longitudinal axis is great,
thereby to provide a substantially uniform temperature on the entire electrode surface upon the heating thermal.

28. Analyzing apparatus according to claim 27, wherein the ratio of the cross-section area perpendicular to the longitudinal axis of the electrode varies from a smallest ratio of 1:1 to a largest ratio of 1:3.

29. Analyzing apparatus according to claim 27, further comprising an electrochemical measuring instrument connected to the heating current contacts

30. Analyzing apparatus according to claim 27, wherein the electrode comprises an electrically conductive wire, strip or fiber.

31. Analyzing apparatus according to claim 27, further comprising an additional contact between the ends of the electrode for connection to an electrochemical measuring instrument.

32. Analyzing apparatus according to claim 31, further comprising an electrochemical measuring instrument connected to the additional contact.

33. Analyzing apparatus according to claim 27, further comprising sonde molecules carried on the electrode surface.

34. Analyzing apparatus according to claim 27, further comprising at least one temperature sensor for measuring temperature of the electrode surface and a controller connected to the electrode.

35. Analyzing apparatus according to claim 27, comprising a plurality of the electrodes and, for individual temperature control of the respective electrodes, respective controllers connected to respective resistors for the heating currents and respective ammeters and voltmeters for measuring the resistance of each of the electrodes.

36. Analyzing apparatus according to claim 27, comprising a plurality of the electrodes and, for each of the electrodes, a respective field-effect transistor having a gate with which a respective one of the electrodes is in indirect or direct contact whereby the field-effect transistors carry out potentiometry.

37. Analyzing apparatus according to claim 23, further comprising respective electrical current supply leads connected to the respective contacts and respective circuit breakers in the supply leads.

38. Analyzing apparatus according to claim 37, wherein the circuit breakers are multiple double circuit breakers.

39. Analyzing apparatus according to claim 27, comprising a plurality of the electrodes, the electrodes being electrically separated from each other, and respective transducers connected to each of the electrodes for supplying of the heating current thereto respective transducers.

40. Analyzing apparatus according to claim 27, further comprising at least one Peltier element or a passive heat sink arranged for contacting a sample solution while the sample solution is in contact with the at least one electrode.

41. Method for analysis of a chemical and/or biochemical medium by means of an analyzing apparatus according to claim 27, comprising applying a layer of sonde molecules to a surface of at least one of the electrodes, contacting a sample of the medium with the layer of the sonde molecules while heating the electrode surface to a temperature which is uniform over the surface, and controlling the temperature of the electrode by measuring the resistance thereof and adjusting the heating current in response thereto.

42. Method according to claim 41, further comprising providing resistors for the heating current and adjusting the heating current by means of the resistors.

43. Method according to claim 41, wherein the controlling is electronic.

44. Method according to claim 41, further comprising permanently conductively separating the electrodes from each other, connecting an electrochemical measuring instrument to an additional contact between the heating current contacts, and applying the heating current to each of the electrodes by means of respective transducers thereby to effect simultaneous electrochemical measurements and heating at each of the electrodes free of interferences.

45. Method according to claim 41, further comprising transducing a signal produced by interaction of a sample with the surface of the electrode electrochemically by amperometric titration, DC- or AC-voltammetric titration, potentiometric titration or chronopotentiometric titration, coulometry and/or impedance spectroscopy or by IR-, Raman-, UV-VIS and/or fluorescence spectroscopy or by radiolabeling and radiometry.

46. Method according to claim 41, wherein the sonde molecules comprise molecules which molecularly detect proteins.

47. Method according to claim 41, further comprising analyzing a sample in contact with the surface of the electrode by at least one of the following methods at predetermined temperatures of said surface: amperometric titration, voltammetric titration, potentiometric titration, optical surface plasmon and/or impedance spectroscopy.

48. Method according to claim 41, wherein a stream of a sample is passed in contact with the surface of the electrode.

49. Method according to claim 41, wherein a sample analyzed by means of the apparatus comprises nucleic acid fragments.
